(19) United States
(12) Patent Application Publication
(10) Pub. No.: US 2016/0052451 A1
(43) Pub. Date: Feb. 25, 2016

(54) WILDLIFE TRACKER

(71) Applicants: Kevin O'Kane, Wheeling, IL (US); Debbie Seeler, Wheeling, IL (US)

(72) Inventors: Kevin O'Kane, Wheeling, IL (US); Debbie Seeler, Wheeling, IL (US)

(21) Appl. No.: 14/829,492

(22) Filed: Aug. 18, 2015

Related U.S. Application Data
(60) Provisional application No. 62/038,799, filed on Aug. 18, 2014.

(51) Int. Cl. B60Q 9/00; G01S 17/93; G08G 1/16

(52) U.S. Cl. CPC B60Q 9/008; G08G 1/166; G01S 17/93

(57) ABSTRACT

A tracking device for detecting the presence of an object in an immediate vicinity of a vehicle is provided. The tracking device comprises a housing, a touch screen display mounted on the housing, and at least one audio speaker on the housing. First and second infrared sensors are mounted to opposite pillars of the vehicle. A microprocessor analyzes data collected from the infrared sensors. A mounting bracket connects the housing to the vehicle. The first and second infrared sensors transmit overlapping infrared waves across an approximately one hundred eighty degree range of the vehicle's forward motion. Upon the infrared waves encountering an object, the reflected infrared wave is analyzed by the microprocessor for object type and location and upon determining that the object poses a threat to the vehicle, the tracking device advises of the imminent threat with both audible and visual emergency warnings.

### CLAIM OF PRIORITY

This patent application claims priority under 35 USC 119 (e) (1) from U.S. Provisional Patent Application Ser. No. 62/038,799 filed Aug. 18, 2014, of common inventorship herewith entitled, “Wildlife Tracker,” which is incorporated herein by reference as though the same were set forth in its entirety.

### FIELD OF THE INVENTION

The present invention pertains to the field of vehicular electronic accessories, and more specifically to the field of detection devices.

### BACKGROUND OF THE INVENTION

Inventions are always a product of vision and creativity whether they are world changing inventions like cars and computers or everyday conveniences like pump hairsprays, cordless tools and resealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

More than one million collisions occur nationally each year between motor vehicles and wildlife. These collisions result in approximately twenty nine thousand injuries to motorists, two hundred human deaths and millions of dollars in property damage. Statistics show that while only two percent of deer and car collisions result in human fatalities, approximately eight five percent of motorcycle and deer collisions are deadly to the motorcyclist.

The prior art has put forth several designs for detection devices. Among these are:

U.S. Pat. No. 8,258,942 to Michael Lanzone, Casey Halverson and Todd Katzner describes a housing holding a microprocessor, a power management system, a pair of communication modules, multiple internal antennas, and a plurality of sensors and interfaces. The housing is connected to a mobile object. One of the communication modules connects to a GPS system through one of the antennas. The other communication module connects to a mobile cellular network or a radio or satellite system through the other antennas. The microprocessor uses the GPS system to determine the position of the object. The frequency with which locational fixes are stored is user determined. The microprocessor is reprogrammed interactively by means of a mobile cellular network and creates a data structure for transmission of locational and other environmental data through the mobile cellular or other networks. The microprocessor has an ability to command the unit to separate from the object at an appropriate time to facilitate recovery.

U.S. Pat. No. 7,821,406 to Carole A. Wangrud describes a device inserted subcutaneously, either manually or mechanically, into domesticated or wild animals to assist in tracking domesticated or wild animals. The product and methods of using include GPS transmitting or any other electronic device to locate and find a lost pet, livestock, migratory movements of birds, or the study of any and all aquatic life. A central data base or a location information receiving device allows an owner or caregiver to locate the animals.

U.S. Pat. No. 7,411,512 to Michael L. Domeier describes systems and techniques for tracking the geographic location. In one aspect, a method includes receiving timed magnetic field information descriptive of a magnetic field to which a magnetometer was subject. The magnetic field information is collected while the magnetometer associated with an animal receives timed longitude information descriptive of a longitude position of the animal. The longitude information is collected while the magnetometer associated with the animal matches the longitude information that is relevant to a first time to the magnetic field information that is relevant to the first time to determine a geographic location of the animal at the first time.

None of these prior art references describe the present invention.

### SUMMARY OF THE INVENTION

It is an object of the present invention to provide an electronic device that detects a presence of animals such as deer, moose and cattle in a vehicle's immediate vicinity, advising a driver of the imminent threat with both audible and visual emergency warnings.

It is an additional object of the present invention to provide an electronic device that detects a presence of animals such as deer, moose and cattle in the immediate vicinity of a cyclist or hiker advising a cyclist or hiker of the imminent threat with both audible and visual emergency warnings.

The present invention is a tracking device for detecting the presence of an object in an immediate vicinity of a vehicle. The vehicle has a windshield mounted between a first windshield pillar and a second windshield pillar and a rear view mirror mounted on or adjacent the windshield. The tracking device comprises a housing having a front side and a rear side, a touch screen display mounted on the front side of the housing, and at least one audio speaker on the housing. A first infrared sensor and a second infrared sensor are capable of being mounted to the first pillar of the vehicle. A microprocessor analyzes data collected from the first and second infrared sensors. A mounting bracket is mounted to the rear side of the housing with the mounting bracket capable of connecting the housing to the vehicle. The first infrared sensor and the second infrared sensor transmit overlapping infrared waves across an approximately one hundred eighty degree range of the vehicle's forward motion. A third infrared sensor is mounted inside the unit for use when one of the external sensors is not being used. Upon the infrared waves encountering an object, the reflected infrared wave returns to the first and second infrared sensors where it is analyzed by the microprocessor for object type and location and upon determining that the object poses a threat to the vehicle, the tracking device advises of the imminent threat with both audible and visual emergency warnings.

In addition, the present invention includes a method for detecting the presence of an object in an immediate vicinity of a vehicle. The vehicle has a windshield mounted between a first windshield pillar and a second windshield pillar and a rear view mirror mounted on or adjacent the windshield. The method comprises providing a housing having a front side and a rear side, mounting a touch screen display on the front side of the housing, mounting at least one audio speaker on the housing, mounting a first infrared sensor to the first pillar of the vehicle, mounting a second infrared sensor to the second pillar of the vehicle, having a third infrared sensor inside the unit. analyzing data collected from at least two of the first, second and third infrared sensors, mounting the housing to the vehicle, transmitting overlapping infrared waves across an approximately one hundred eighty degree range of the vehicle's forward motion, encountering an object with the infrared waves, analyzing the reflected infrared wave for object type and location, and determining that the object poses a threat to the vehicle and advising of the imminent threat with both audible and visual emergency warnings.

### BRIEF DESCRIPTION OF THE DRAWINGS

FIG. 1 is a front perspective view illustrating the present invention with its display screen attached to included brackets for mounting the screen to any style rear view mirror.

FIG. 2 is a front perspective view illustrating the present invention clipped to a rearview mirror in a vehicle.

FIG. 3 is a rear perspective view illustrating the present invention inside the front area of a vehicle.

FIG. 4 is a rear perspective view illustrating the present invention with pivotable mounting brackets attached to the back side.

### DETAILED DESCRIPTION OF THE INVENTION

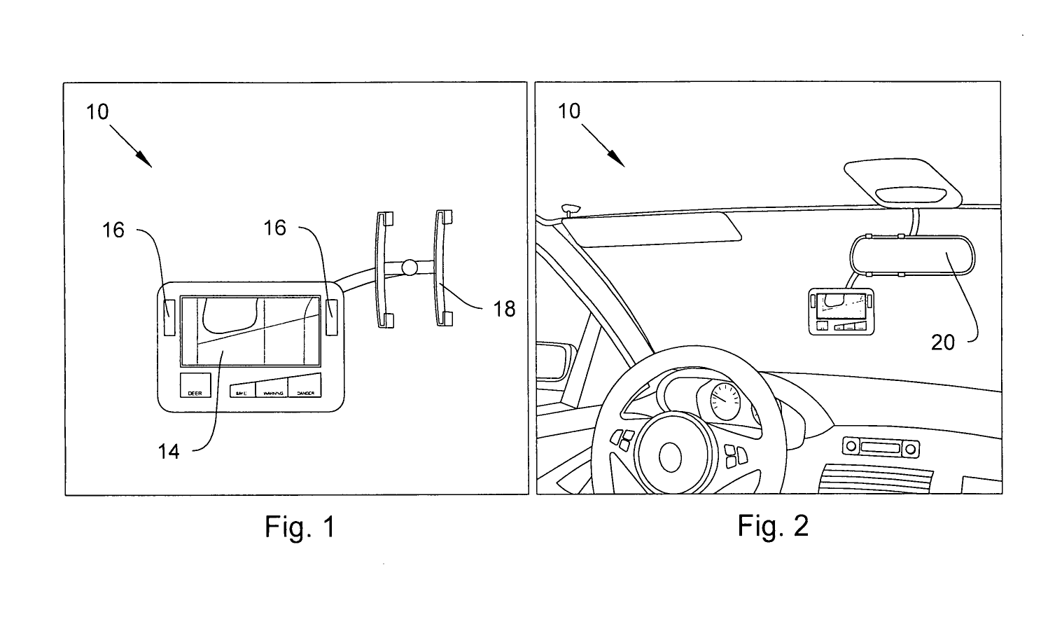

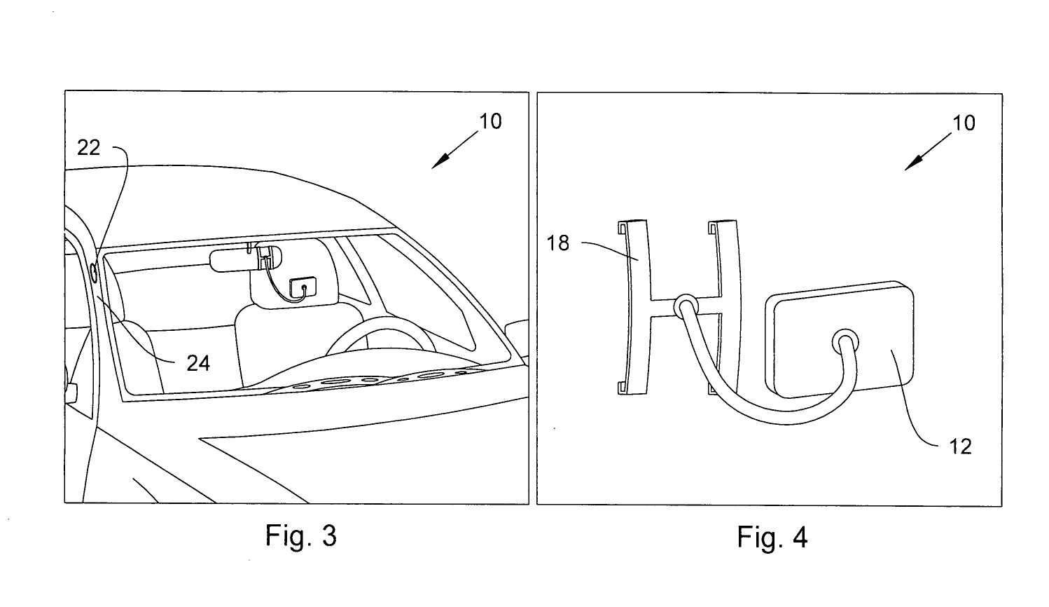

As illustrated in FIGS. 1-4, the present invention, hereinafter referred to as the Wildlife Tracker, indicated generally at 10, equips motorists with an electronic device constructed to detect presence of animals such as deer, moose and cattle in their immediate vicinity, advising a driver of the threat through both an audible and a visual emergency warning to the driver. The Wildlife Tracker 10 is highly functional for bicyclists, motorcyclists, truckers and wildlife enthusiasts. The Wildlife Tracker 10 is a portable remote detection and early warning system intended primarily for use within a motor vehicle to detect the presence, position and distance of wildlife from the vehicle. Compact and rectangular in shape, the Wildlife Tracker 10 of the present invention preferably measures approximately four inches in length, approximately two and one half inches in height, and approximately one and one half inches in depth or thickness. The Wildlife Tracker 10 is equipped with a housing 12, bright touch screen display 14, two audio speakers 16, and an adjustable rear mount bracket 18 that permits clipping to the bottom of a vehicle's interior rear view mirror 20. The Wildlife Tracker 10 is powered by rechargeable lithium ion batteries or by an included power cord pluggable into a vehicle's cigarette lighter or auxiliary power port. A power adapter to use household current is also included. The Wildlife Tracker 10 is also capable of being powered and recharged by solar energy by means of a solar cell power supply and charger. The remote sensing capabilities of the Wildlife Tracker 10 depend upon two wide angle infrared sensors 22 that mount on two windshield pillars 24. Alternatively, or in addition, one or more infrared sensors are also built into the device for use when the external infrared sensors are not being used for example, when used on a motorcycle, bicycle, or walking/hiking.

The Wildlife Tracker 10 of the present invention transmits overlapping infrared waves across an approximately one hundred eighty degree range of a vehicle's forward motion. When the radiation encounters an object such as an animal, the reflected infrared wave returns to the sensors 22 of the Wildlife Tracker 10 where the object is focused through a lens and analyzed through a high speed microprocessor. The processor determines whether the object is an animal, what type of animal and the animal's precise location and distance from the vehicle.

The display screen 14 of the Wildlife Tracker 10 of the present invention, which regularly displays a real time GPS map of a vehicle's location in the immediate vicinity of roads and highways, will beep audibly while a brightly lit animal icon in one of three colors lights up to indicate the sensed animal's exact position. The bottom of the screen 14 displays a three color bar that lights up differentially depending on the imminence of the threat. A green light indicates the animal is at a safe distance, a yellow light is a warning that the animal is closer to the vehicle, and a red light indicates the animal is dangerously close at an immediate distance. The animal icon also lights up in these colors as well, indicating the nearness of the threat.

The Wildlife Tracker 10 of the present invention is programmed to issue warnings verbally. These verbal warnings take the form of a male or female speaking voice and convey a specific animal's location, its relative position to the vehicle and its exact distance from the vehicle. If the collision threat is imminent, the verbal warning shifts from a calm but firm advisory mode to an urgent and commanding alarm mode.

A discrete and stand alone device, other embodiments of the Wildlife Tracker 10 of the present invention are incorporable into a vehicular GPS's functionality and into a software application for GPS equipped smart phones. These embodiments are contingent on development of hardware and software necessary to receive and interpret infrared signals of the sensor system of the Wildlife Tracker 10. Portable and easily interchangeable between vehicles, each Wildlife Tracker 10 embodiment is usable with different vehicles.

Using the Wildlife Tracker 10 of the present invention provides a driver with a sense of confidence and lowers their level of anxiety and stress. This automotive accessory safety system also works well for outdoor enthusiasts such as campers, hikers, hunters and angler as well as wildlife researchers, photographers and biologists who can use the present invention to seek out wildlife. Innovatively engineered and durably constructed, the Wildlife Tracker 10 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A tracking device for detecting the presence of an object in an immediate vicinity of a vehicle, the vehicle having a windshield mounted between a first windshield pillar and a second windshield pillar and a rear view mirror mounted on or adjacent the windshield, the tracking device comprising:
a housing having a front side and a rear side;
a touch screen display mounted on the front side of the housing;
at least one audio speaker on the housing;
a first infrared sensor capable of being mounted to the first pillar of the vehicle;
a second infrared sensor capable of being mounted to the second pillar of the vehicle;
a third infrared sensor capable of being mounted inside the device;
a microprocessor for analyzing data collected from the first second and third infrared sensors; and
a mounting bracket mounted to the rear side of the housing, the mounting bracket capable of connecting the housing to the vehicle;
wherein at least two sensors of the first infrared sensor, the second infrared sensor and the third infrared sensor transmit overlapping infrared waves across an approximately one hundred eighty degree range of the vehicle's forward motion;
wherein upon the infrared waves encountering an object, the reflected infrared wave returns to the first and second infrared sensors where it is analyzed by the microprocessor for object type and location; and
wherein upon determining that the object poses a threat to the vehicle, the tracking device advises of the imminent threat with both audible and visual emergency warnings.

2. The tracking device of claim 1 wherein the mounting bracket is capable of connecting the housing to the rear view mirror.

3. The tracking device of claim 1 and further comprising:
a first speaker mounted on one side of the touch screen display; and
a second speaker mounted on the other side of the touch screen display.

4. The tracking device of claim 1 wherein the tracking device is powered by one or more of the following, alone or in combination:
rechargeable lithium ion batteries,
an included power cord pluggable into a vehicle's cigarette lighter or auxiliary power port,
a power adapter to use household current, and
solar energy by means of a solar cell power supply and charger.

5. The tracking device of claim 1 wherein the touch screen display displays a real time GPS map of the vehicle's location in the immediate vicinity of roads and highways and wherein the tracking device beeps audibly while a brightly lit animal icon is displayed.

6. The tracking device of claim 5 wherein the touch screen display displays one of three colors lights up to indicate the sensed object's position, a different color light indicates the closeness of the object to the vehicle.

7. The tracking device of claim 6 wherein a green light indicates the sensed object is located at a safe distance, a yellow light indicates a warning that the sensed object is close to the vehicle, and a red light indicates the sensed object is dangerously close to the vehicle.

8. The tracking device of claim 5 and further comprising:
an animal icon displayed on the display screen indicating that the sensed object is an animal.

9. The tracking device of claim 7 and further comprising:
an animal icon displayed on the display screen in a color indicating the distance of the animal to the vehicle.

10. The tracking device of claim 1 wherein the audible warning conveys a specific object's location, its relative position to the vehicle, and its exact distance from the vehicle.

11. The tracking device of claim 1 wherein the audible warning shifts from a calm but firm advisory mode to an urgent and commanding alarm mode when the collision is imminent.

12. The tracking device of claim 1 wherein the object is an animal.

13. The tracking device of claim 12 wherein the animal is selected from the group consisting of deer, elk, moose, and cattle.

14. The tracking device of claim 12 wherein the type of animal is audibly and/or visually announced.

15. A method for detecting the presence of an object in an immediate vicinity of a vehicle, the vehicle having a windshield mounted between a first windshield pillar and a second windshield pillar and a rear view mirror mounted on or adjacent the windshield, the method comprising:
providing a housing having a front side and a rear side;
mounting a touch screen display on the front side of the housing;
mounting at least one audio speaker on the housing;
mounting a first infrared sensor to the first pillar of the vehicle;
mounting a second infrared sensor to the second pillar of the vehicle;
analyzing data collected from the first and second infrared sensors;
mounting the housing to the vehicle;
transmitting overlapping infrared waves across an approximately one hundred eighty degree range of the vehicle's forward motion;
encountering an object with the infrared waves;
analyzing the reflected infrared wave for object type and location; and
determining that the object poses a threat to the vehicle and advising of the imminent threat with both audible and visual emergency warnings.

16. A tracking device for detecting the presence of an object in an immediate vicinity of a vehicle, the vehicle having a windshield mounted between a first windshield pillar and a second windshield pillar and a rear view mirror mounted on or adjacent the windshield, the tracking device comprising:
a housing having a front side and a rear side;
a touch screen display mounted on the front side of the housing, the touch screen display displays a real time GPS map of the vehicle's location in the immediate vicinity of roads and highways;
at least one audio speaker on the housing;
a first infrared sensor capable of being mounted to the first pillar of the vehicle;
a second infrared sensor capable of being mounted to the second pillar of the vehicle;
a first speaker mounted on one side of the touch screen display;
a second speaker mounted on the other side of the touch screen display;
a microprocessor for analyzing data collected from the first and second infrared sensors; and
a mounting bracket mounted to the rear side of the housing, the mounting bracket capable of connecting the housing to the rear view mirror of the vehicle;
wherein the first infrared sensor and the second infrared sensor transmit overlapping infrared waves across an approximately one hundred eighty degree range of the vehicle's forward motion;
wherein upon the infrared waves encountering an object, the reflected infrared wave returns to the first and second infrared sensors where it is analyzed by the microprocessor for object type and location; and
wherein upon determining that the object poses a threat to the vehicle, the tracking device conveys a specific object's location, its relative position to the vehicle, and its exact distance from the vehicle, and advises of the imminent threat with both audible and visual emergency warnings.

17. The tracking device of claim 16 wherein and wherein the tracking device beeps audibly while a brightly lit animal icon is displayed. the rear view mirror of the vehicle;
wherein the first infrared sensor and the second infrared sensor transmit overlapping infrared waves across an approximately one hundred eighty degree range of the vehicle's forward motion;
wherein upon the infrared waves encountering an object, the reflected infrared wave returns to the first and second infrared sensors where it is analyzed by the microprocessor for object type and location; and
wherein upon determining that the object poses a threat to the vehicle, the tracking device conveys a specific object's location, its relative position to the vehicle, and its exact distance from the vehicle, and advises of the imminent threat with both audible and visual emergency warnings.

17. The tracking device of claim 16 wherein and wherein the tracking device beeps audibly while a brightly lit animal icon is displayed.

18. The tracking device of claim 17 wherein the touch screen display displays one of three colors lights up to indicate the sensed object's position, a different color light indicates the closeness of the object to the vehicle.

19. The tracking device of claim 18 wherein a green light indicates the sensed object is located at a safe distance, a yellow light indicates a warning that the sensed object is close to the vehicle, and a red light indicates the sensed object is dangerously close to the vehicle.

20. The tracking device of claim 5 and further comprising:
an animal icon displayed on the display screen indicating that the sensed object is an animal.
